(19) United States
(12) Patent Application Publication
(10) Pub. No.: US 2002/0018074 A1
(43) Pub. Date: Feb. 14, 2002

(54) System for browsing a collection of information units

(76) Inventors: Vincentius Paulus Buil, Eindhoven (NL); Josephus Hubertus Eggen, Eindhoven (NL)

Correspondence Address: Philips Electronics North America Corp., 580 White Plains Road, Tarrytown, NY, 10591, US

(21) Appl. No.: 09/932,070

(22) Filed: Aug. 17, 2001

(30) Foreign Application Priority Data
Jul. 28, 2000 (EP) 00202707.6

(51) Int. Cl. G06F 3/00; G06F 13/00

(52) U.S. Cl. 345/719; 725/38; 345/716; 345/727

(57) ABSTRACT

The invention relates to a system for browsing a collection of information units, such as audio or video files, comprising presentation means for presenting an information unit from said collection, and attribute means for associating a respective information unit with an attribute value for at least a first attribute. The system according to the invention randomly selects information units which meet certain criteria for said first attribute.

### FIELD OF THE INVENTION

The invention relates to a system for browsing a collection of information units, comprising presentation means for presenting at least one of said information units, and attribute means for associating a respective one of said information units with an attribute value.

The invention further relates to a method of browsing a collection of information units, comprising a step of presenting an information unit from said collection and a step of associating a respective information unit with an attribute value for at least a first attribute.

### BACKGROUND OF THE INVENTION

Recent developments in music compression, storage capacity and broad-band networks have made it possible that consumers have access to large quantities of information of various kinds. For example, a database of compressed music files may be stored on the hard disk of a personal computer and browsed and listened to by the user. Alternatively, music files may be stored on a remote server, and accessed via a computer network such as the internet. Examples of such on-line jukeboxes can be found at www.musicmatch.com, www.mp3.com and www.music.sony.communication/jukebox.

A disadvantage of the known systems is that finding a suitable song in such a collection is difficult if the user does not precisely know what he wants to hear or what music is available in the collection. The known systems are not very helpful in this respect, because they are designed to find specific songs or albums the user has in mind.

### OBJECT AND SUMMARY OF THE INVENTION

It is an object of the invention to provide a system and method of the type defined in the opening paragraph which enables a user to easily explore the collection of information units. To that end, the invention provides a system wherein the system comprises random selection means for randomly selecting a unit for presentation whose attribute value meets a criterion. In this way it is achieved that the user need not precisely specify which information he wants to be presented with, because the system makes suggestions by selecting more or less arbitrary units from the collection. The degree of randomness can be limited by requiring that selected units meet one or more criteria with respect to their attribute values. Such criteria may be entered by the user, or generated by the system as a result of, for example, habit watching, which is a well-known technique for inferring the user's preferences from his earlier selections. An example of an attribute is the ‘genre’ of a music file, and a criterion with respect to this attribute could be ‘genre is jazz’. If this criterion were entered, the system according to the invention would randomly select a song whose genre attribute value corresponds to ‘jazz’. After presentation of this song, the system would select another arbitrary jazz song, without requiring any user action. In this way the user can explore the collection with minimal effort.

An advantageous embodiment of the system according to the invention is characterized by said system comprising user-operable hold means for holding an attribute value of a currently selected unit as a criterion for subsequent selections. This provides a very user-friendly way of restricting the set of information units from which the random selection means may select a unit for presentation. The user need only indicate that he wants to hold the attribute value of the currently selected unit constant for subsequent selections. For example, if the currently selected unit happens to be a jazz song, the user can easily control the random selection means to select only music files whose genre attribute values correspond to jazz. This can be achieved by a simple operation, e.g. by pressing a button, and does not require explicit indication of the desired attribute value, since this attribute value is uniquely determined by the currently selected unit.

An embodiment of the system according to the invention is characterized by said attribute value being defined with respect to a first attribute, said attribute means being adapted to determine a set of valid attribute values for a further attribute in dependence on said criterion. In general, information units will be described by multiple attributes, some of them being subordinate to other attributes. For example, in addition to the genre attribute, a ‘style’ attribute, i.e. a sub-genre, may be defined, whose set of valid attribute values depends on the currently selected value of the genre attribute. If the currently selected value for the ‘genre’ attribute is ‘jazz’, the resultant set of valid values of the ‘style’ attribute may include values such as ‘bebop’, ‘mainstream’, ‘swing’, etc. This helps the user in getting an overview of valid attribute values for the current criteria, and inputting further criteria for said further attribute.

An embodiment of the system according to the invention is characterized by the system further comprising user-operable skip means for controlling the random selection means to abort the presentation of the currently selected unit and to skip to a randomly selected alternative unit whose attribute value meets said criterion. In this way it is achieved that if the user does not like a currently selected unit, he can easily stop its presentation and cause the random selection means to choose an alternative unit which also meets the current criteria. The user is thus able to quickly explore the collection, without explicitly selecting units for presentation. He need only operate the skip means, which may take the form of a simple button, to select the alternative unit.

An embodiment of the system according to the invention is characterized by said skip means being capable of removing at least one criterion in dependence on a mode of operation of said skip means. This provides an extremely quick and intuitive way of requesting the presentation of another information unit. A ‘default’ mode of operation of the skip means, e.g. simply pressing a skip button, invokes the normal function of the skip means, as described above. A slightly deviant mode of operation, however, will remove one or more criteria a before invoking the normal skip function and thus widen the search space of the random selection means. Preferably, criteria for dependent attributes are removed before criteria for attributes they depend on. For example, a criterion for the ‘style’ attribute would be removed before a criterion for the ‘genre’ attribute, which gradually widens the search space. Examples of such deviant operations are iterated or prolonged operation, e.g. pressing the skip button a second time shortly after the first time to remove a criterion for an ‘artist’ attribute, pressing three times to remove criteria for both the ‘artist’ and the ‘style’ attribute, pressing for one second to remove criteria for the ‘artist’, the ‘style’ and ‘genre’ attributes, etc.

An advantageous embodiment of the system according to the invention is characterized by the attribute means being adapted to determine a distance between a pair of attribute values, the random selection means being capable of selecting a unit from units whose attribute values have a relatively large distance to attribute values of an earlier selected unit. The units suggested by the system thus differ as much as possible, or at least significantly, from earlier suggestions. In this way it is achieved that the user gets a quick overview of the various kinds of units in the collection, with little chance of being faced with long series of similar units. Hence, the exploration of the collection becomes more surprising and attractive.

An embodiment of the system according to the invention is characterized by the system comprising display means for displaying a simulation of a slot machine, an operation of said simulated slot machine representing said random selection, and each cylinder of said slot machine representing a set of valid attribute values for an attribute. The process of random selection is thus visualized by means of a slot machine simulation. Each cylinder then corresponds to an attribute and shows the valid attribute values for that attribute. The ‘arm’ of the slot machine may be simply represented as a button or visualized by a graphical representation of such an arm, which is operated by, for example, a downward stroke with a mouse-controlled cursor or with a finger on a touch screen. Operation of the ‘arm’ aborts the presentation of the currently selected unit and starts a random selection of another unit, which is visualized by a rotation of the cylinders. If the new unit is selected, its presentation starts and the front values of the cylinders reflect the attribute values of the newly selected unit. In this way a very attractive and intuitive user interface is obtained for exploring the collection of information units. Preferably, each cylinder is associated with a hold button to enable the user to hold the corresponding attribute constant for subsequent selections. If such a hold button is pressed, the corresponding cylinder does not rotate during the random selection. Pressing the hold button again causes the criterion to be removed again. The invention is particularly suitable for exploring a collection of audio or video tracks, which are stored in a CD-changer, on a computer hard disk or on a remote server. The invention further relates to a computer program product for causing a programmable device, when executed on said device, to constitute a system according to the invention.

### BRIEF DESCRIPTION OF THE DRAWINGS

These and other aspects of the invention are apparent from and will be elucidated, by way of a non-limitative example, with reference to the embodiment(s) described hereinafter. In the drawings,

FIG. 1 shows a diagram of a music browser as an embodiment of the system according to the invention,

FIG. 2 shows an example of a user interface to a music browser according to the invention,

FIG. 3 shows a compact embodiment of the music browser according to the invention.

### DESCRIPTION OF EMBODIMENTS

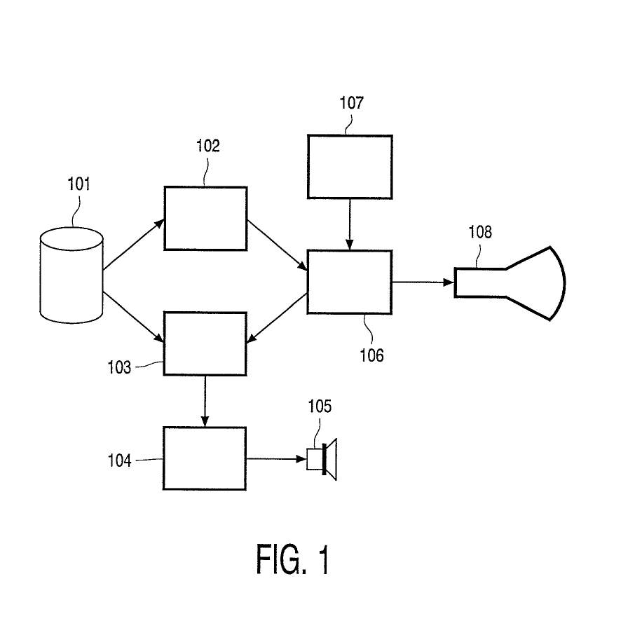

FIG. 1 shows a diagram of a music browser as an embodiment of the system according to the invention. The music browser comprises a database 101 for storing and retrieving music files. The database 101 may be a CD-changer, a computer hard disk or an on-line database of music files. Songs in the database 101 are described by attribute means 102, which may be a digital memory for storing definitions of attributes and attribute-value pairs corresponding to songs in the database 101. Random selection means 103 are capable of randomly selecting a music file from the database 101 and sending it to an audio processor 104 and a loudspeaker 105, which thus constitute presentation means for presenting the audio file. The random selection of music files may be influenced by a criterion manager 106, which defines criteria based on attribute definitions of the attribute means 102 and controls the random selection means 103 to select only music files whose attribute values meet said criteria. Such criteria may be explicitly entered by the user through input means 107, comprising a keyboard and a mouse, or alternatively, a speech recognition system or any other suitable input means. Visual feedback is provided through a display screen 108.

The diagram of FIG. 1 shows various distinct components, which may be implemented as distinct hardware components. However, any other configuration comprising the functions according to the invention suffice as well. For example, the system could be implemented by executing a suitable computer program product on a personal computer, maintaining a database of attributed music files on its hard disk and retrieving files through well-known database retrieval techniques and presenting them via the computer's sound card and loudspeakers.

In the absence of user interaction, the music browser will repeatedly select and present arbitrary songs from the database 101, in accordance with any criteria defined by the criterion manager 106. Criteria may be added, edited and removed using any suitable input technique, e.g. by entering text strings such as “genre is rock”, or by selections from menus presented on the display screen 108. Such menus are generated on the basis of the attribute definitions maintained by the attribute means 102. For example, in the absence of any criteria, the system may present a menu with all valid attribute values for the ‘genre’ attribute. Selecting such a value defines a criterion equating the ‘genre’ attribute with the selected value. If there exists an attribute which is dependent on the ‘genre’ attribute, i.e. a ‘sub-genre’ or ‘style’ attribute, the system may present a menu with attribute values which are valid in view of the criterion for the ‘genre’ attribute.

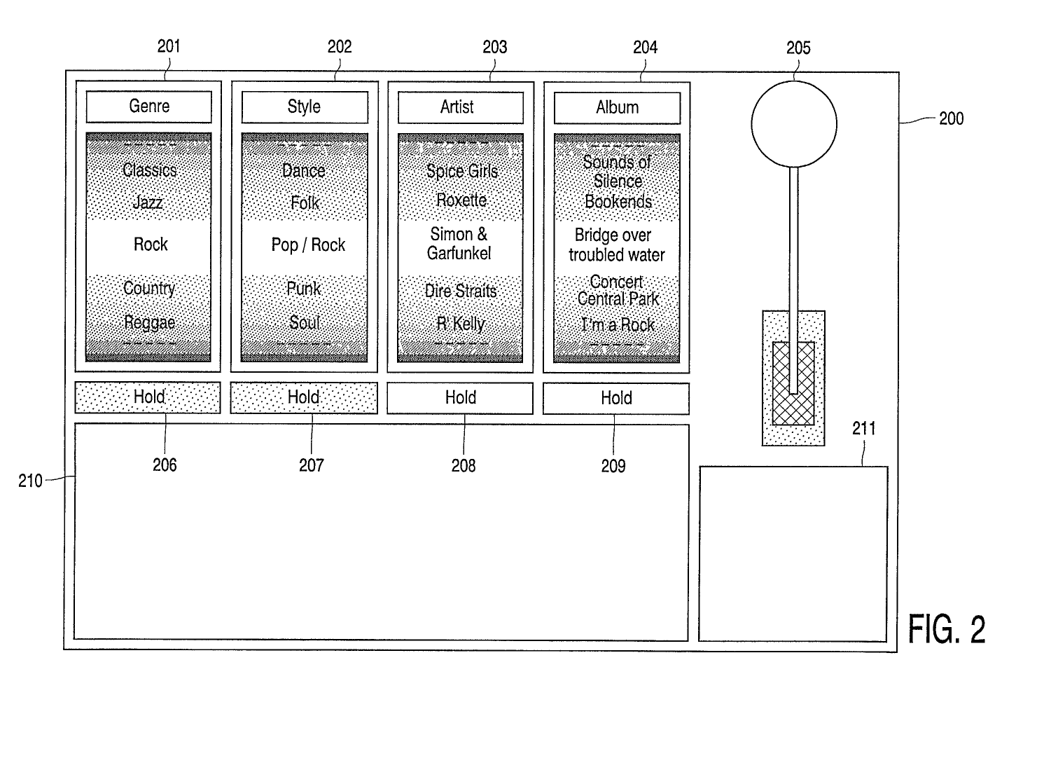

FIG. 2 shows an example of a very attractive input means to a music browser according to the invention. The music browser is controlled through a graphical simulation of a slot machine 200. It comprises four cylinders 201, 202, 203 and 204, corresponding to respectively a ‘genre’ attribute, a ‘style’ attribute, an ‘artist’ attribute and an ‘album’ attribute. Each attribute, except for the ‘genre’ attribute is subordinate to the attribute corresponding to the cylinder to its left. The valid attribute values for the respective attribute, at option with respect to a higher-order attribute, are depicted on each cylinder. The value in front represents the currently selected value.

Operation of an arm 205 starts the random selection process visualized by the rotation and eventual halting of the cylinders 201 to 204. Operation of the arm 205 is accomplished by dragging the knob of the arm downward, either by means of a mouse or by a stylus or finger in the case of a touch screen. In an alternative embodiment the arm 205 could be operated by simply clicking with the mouse, or with a voice command.

Adjacent to each cylinder, a hold button 206, 207, 208 and 209 is provided. By pressing such a hold button, the user indicates that he wants to put a hold on the currently selected value of the corresponding attribute. The currently selected value for the ‘genre’ attribute is held constant, for example by pressing hold button 206, as a result of which a criterion is established which equates the ‘genre’ attribute to the currently selected value. Similarly, pressing hold button 207 establishes criteria for both the ‘genre’ and the ‘style’ attribute, based on their respective currently selected values. Pressing the hold button 208 additionally establishes a criterion for the ‘Artist’ attribute, and pressing the hold button 209 adds another criterion for the ‘Album’ attribute. Hence, pressing a hold button puts a hold on the corresponding cylinder and all the cylinders to the left so as to allow for the interdependency between the attributes. In other embodiments, the cylinders may be ordered from right to left, or in an arbitrary order. FIG. 2 shows a state wherein there is a hold on the ‘genre’ and the ‘style’ attribute, which is indicated by a deviant color of the respective hold buttons.

Although such a hierarchy of attributes offers a convenient and intuitive way of structuring the collection, the invention may equally well be applied to a browsing system based on mutually independent attributes. For example, in addition to the attributes mentioned above, the system could define an attribute indicating a mood of a song, the. nationality of the performer, or a distinction between vocal and instrumental music. Such attributes are more or less independent of the genre and style of the song. Putting a hold on such an independent attribute will not affect the state of other attributes.

In order to present songs with as much variation as possible, the system may take into account a distance between each pair of songs, which may, for example, be defined as the sum of the distances between the attribute values of each song. The distance between attribute values may in turn be predefined and stored permanently in the attribute means 102. For example, suppose for ease of explanation that all songs could be divided into only three main genres: classical, jazz and rock. The distance between classical and jazz and the distance between jazz and rock could be set to one, while the distance between classical and rock could be set to two. Similarly, a distance between various styles of a particular genre may be defined. A distance between various albums of a particular artists may be determined by, for example, the chronological order of the albums. A distance between various artists may be determined by the combination of personal data such as country, age and sex. For example, to obtain a relatively varied presentation, a song by a young American female artist may be followed by an older European male artist.

In addition to the typical slot machine parts described above, windows 210 and 211 have been provided respectively, to display information about the currently selected album and/or song, and to create control elements for typical audio functions as play, stop, pause, elapsed time indication, and next/previous track (for the currently selected album).

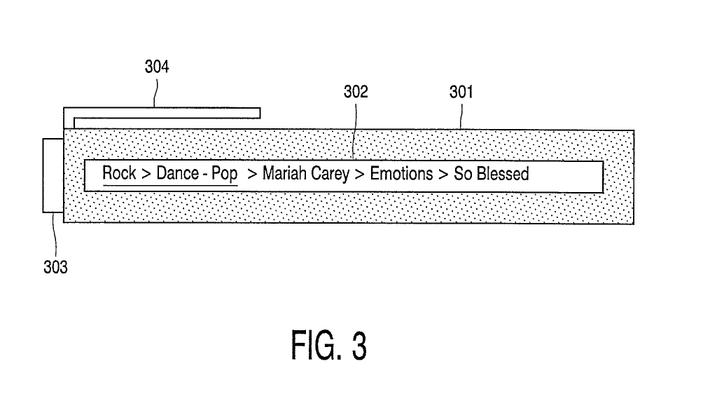

FIG. 3 shows a very compact embodiment of the music browser according to the invention. It comprises a pen-shaped device with a solid-state memory for storing compressed music files, e.g. in accordance with the MP3 format. The music files can be listened to via an earphone (not shown). Clearly, such a tiny device cannot accommodate many control elements enabling the user to control it. The device 301 of FIG. 3 comprises only a LCD 302 for displaying textual information and a button 303 for controlling the browsing process. A clip 304 serves to attach the device to one's clothes. Further controls for basic audio functions as volume and tone control may be added but are not considered here.

It is assumed that the same hierarchy of attributes is used here, and that memory capacity is large enough to justify a browsing system according to the invention. Again, in the absence of any user interaction, the system repeatedly selects and presents arbitrary songs, optionally in accordance with currently defined criteria. The LCD 302 shows at any moment the genre, the style, the artist, the album and the song, in that order to reflect the decreasing scope. The currently defined criteria are visualized by emphasizing the corresponding attribute values, e.g. in the present example the values ‘rock’ and ‘dance-pop’ are displayed in bold face and/or underlined to indicate that the genre and the style are held constant. Pressing the button 303 shortly selects another song meeting the ‘rock>dance-pop’ criteria, which may be a track from a completely different artist and/or album. Pressing twice removes the criterion with the smallest scope, i.e. the ‘style’ criterion, and subsequent songs are selected within the ‘rock’ genre. Pressing three times removes two criteria at once, i.e. those for ‘style’ and ‘genre’, resulting in a non-constrained search space.

In an alternative embodiment, the manner of operating the button 303 is directly coupled to the various attributes. For example:

pressing once selects another song from the currently selected album,

pressing twice selects an arbitrary song from another album of the same artist,

pressing three times selects an arbitrary song from an arbitrary album of a different artist within the currently selected style,

pressing for about one second selects an arbitrary song within the current genre,

pressing for more than two seconds selects an arbitrary song in an arbitrary genre.

In this case, the currently selected criteria are determined by the last user action. For example, if the user presses three times and refrains from any further action, the system will repeatedly select and present songs within the currently selected genre and style, in other words, pressing three times establishes criteria for the genre and style attributes.

In summary, the invention relates to a system for browsing a collection of information units, such as audio or video files, comprising presentation means for presenting an information unit from said collection, and attribute means for associating a respective information unit with an attribute value for at least a first attribute. The system according to the invention randomly selects information units which meet certain criteria for said first attribute.

Although the invention has been described with reference to particular illustrative embodiments, variants and modifications are possible within the scope of the inventive concept.

The use of the verb “to comprise” and its conjugations does not exclude the presence of any elements or steps other than those defined in a claim. In the claims, any reference signs placed between parentheses shall not be construed as limiting the claim. The invention can be implemented by means of hardware comprising several distinct elements, and by means of a suitably programmed computer. In the device claim defining several means, several of these means can be embodied by one and the same item of hardware.

A ‘computer program’ is to be understood to mean any software product stored on a computer-readable medium, such as a floppy-disk, downloadable via a network, such as the Internet, or marketable in any other manner.

1. A system for browsing a collection of information units, comprising presentation means for presenting at least one of said information units, and attribute means for associating a respective one of said information units with an attribute value, wherein the system comprises random selection means for randomly selecting a unit for presentation whose attribute value meets a criterion.

2. A system as claimed in claim 1, said system comprising user-operable hold means for holding an attribute value of a currently selected unit as a criterion for subsequent selections.

3. A system as claimed in claim 1 or 2, said attribute value being defined with respect to a first attribute, said attribute means being adapted to determine a set of valid attribute values for a further attribute in dependence on said criterion.

4. A system as claimed in claim 3, said first attribute representing a genre of said information units and said further attribute representing a sub-genre of said information units.

5. A system as claimed in any one of claims 1 to 4, said information units comprising audio and/or video information.

6. A system as claimed in any one of claims 1 to 5, the system further comprising user-operable skip means for controlling the random selection means to abort the presentation of the currently selected unit and to skip to a randomly selected alternative unit whose attribute value meets said criterion.

7. A system as claimed in claim 6, said skip means being capable of removing at least one criterion in dependence on a mode of operation of said skip means.

8. A system as claimed in claim 7, said removing of said criterion being determined by an iterated and/or prolonged operation of said skip means.

9. A system as claimed in any one of claims 1 to 8, the attribute means being adapted to determine a distance between a pair of attribute values, the random selection means being capable of selecting a unit from units whose attribute values have a relatively large distance to attribute values of an earlier selected unit.

10. A system as claimed in any one of claims 1 to 9, the system comprising display means for displaying a simulation of a slot machine, an operation of said simulated slot machine representing said random selection, and each cylinder of said slot machine representing a set of valid attribute values for an attribute.

11. A method of browsing a collection of information units, comprising a step of presenting an information unit from said collection and a step of associating a respective information unit with an attribute value for at least a first attribute, wherein the method comprises a step of randomly selecting a unit for presentation from information units whose attribute values meet a criterion for said first attribute

12. A method as claimed in claim 11, further comprising a step of user operably holding an attribute value of a currently selected unit as a criterion for subsequent selections.

13. A computer program product for causing a programmable device, when executed on said device, to constitute a system as claimed in any one of claims 1 to 10.
